(19) United States
(12) Patent Application Publication
(10) Pub. No.: US 2024/0326269 A1
(43) Pub. Date: Oct. 3, 2024

(54) ROBOT APPENDAGE FORCE DAMPENING

(71) Applicant: Commonwealth Scientific and Industrial Research Organisation, Acton, Australian Capital Territory (AU)

(72) Inventors: Navinda KOTTEGE, Acton (AU); Ryan STEINDL, Acton (AU); Simon MURRELL, Acton (AU)

(73) Assignee: Commonwealth Scientific and Industrial Research Organisation, Acton, Australian Capital Territory (AU)

(21) Appl. No.: 18/578,987

(22) PCT Filed: Jul. 14, 2022
(86) PCT No.: PCT/AU2022/050740

§ 371 Date: Jan. 12, 2024

(30) Foreign Application Priority Data
Jul. 19, 2021 (AU) 2021902218

(51) Int. Cl. B25J 19/00

(52) U.S. Cl. CPC B25J 19/0091

(57) ABSTRACT

An apparatus for dampening forces on a robot appendage, the apparatus including: a body; a flexible membrane attached to the body to define an internal cavity, the membrane being configured to deform in response to an applied force; an outlet valve configured to allow fluid transfer out of the internal cavity as the flexible membrane deforms whereby, as fluid is transferred out of the internal cavity, the applying force is dampened; and, an inlet valve configured to allow fluid to transfer into the internal cavity, wherein at least one of the outlet valve and the inlet valve can be interchanged with another valve to adjust at least one of: an amount of fluid that can be transferred; and, a rate at which fluid can be transferred.

### BACKGROUND OF THE INVENTION

The present invention relates to apparatus for dampening forces on a robot appendage.

### DESCRIPTION OF THE PRIOR ART

The reference in this specification to any prior publication (or information derived from it), or to any matter which is known, is not, and should not be taken as an acknowledgment or admission or any form of suggestion that the prior publication (or information derived from it) or known matter forms part of the common general knowledge in the field of endeavour to which this specification relates.

U.S. Pat. No. 6,967,456 discloses a landing shock absorbing device provided in a foot mechanism of a leg of a robot comprising an inflatable and compressible bag-like member on a bottom face side of the foot mechanism. Air in the atmosphere can flow into and out of the bag-like member by inflow/outflow means provide with a solenoid valve and the like. Furthermore, during the mag-like member in the inflating state during the lifting state of the foot mechanism, by controlling timing when the solenoid salve is switched from a valve opening state to a valve closing state, a height of the bag-like member in a compression direction is controlled to be a height suitable for a gait type of robot.

### SUMMARY OF THE PRESENT INVENTION

In one broad form, an apparatus for dampening forces on a robot appendage, the apparatus including: a body; a flexible membrane attached to the body to define an internal cavity, the membrane being configured to deform in response to an applied force; an outlet valve configured to allow fluid transfer out of the internal cavity as the flexible membrane deforms whereby, as fluid is transferred out of the internal cavity, the applying force is dampened; and, an inlet valve configured to allow fluid to transfer into the internal cavity, wherein at least one of the outlet valve and the inlet valve can be interchanged with another valve to adjust at least one of: an amount of fluid that can be transferred; and, a rate at which fluid can be transferred.

In one embodiment, the other valve has at least one of: an increased flow resistance; a reduced flow resistance; an increased flow capacity; and, a reduced flow capacity.

In one embodiment, the inlet valve is configured to allow fluid transfer into the internal cavity after at least one of: the applying force is no longer being applied; and, there is a reduction in the force applied by the applying force.

In one embodiment, the outlet valve includes a diaphragm which is configured to at least partially reduce an amount of fluid or a rate at which fluid can be transferred out of the internal cavity.

In one embodiment, the reduction is determined by at least one of: resistance of the diaphragm; and, size of the diaphragm.

In one embodiment, as the flexible membrane deforms, the reduction in amount of fluid or rate of fluid transfer reduces.

In one embodiment, as the flexible membrane is deformed, the flexible membrane places pressure on the diaphragm so that it temporarily no longer blocks the outlet valve.

In one embodiment, the body includes a storage cavity configured to receive fluid that transfers out of the internal cavity.

In one embodiment, the storage cavity is configured to supply fluid that is transferred into the internal cavity.

In one embodiment, the inlet valve is a one way valve to prevent fluid from transferring from the internal cavity through the inlet valve.

In one embodiment, the outlet valve is a one way valve to prevent fluid from transferring into the internal cavity through the outlet valve.

In one embodiment, the fluid is at least one of: air; and, water.

In one embodiment, at least one of the inlet valve and the outlet value are removably and replaceably attached to the body.

In one embodiment, at least one of the inlet valve and the outlet valve are attached to the body at least one of: magnetically; pneumatically; using a screw fit; using a friction fit; and, using an interference fit.

In one embodiment, the apparatus includes a valve module which includes the outlet valve and the inlet valve.

In one embodiment, the valve module can be interchanged with another valve module in order to interchange at least one of: the inlet valve; and, the outlet valve.

In one embodiment, the valve module is attached to the body at least one of: magnetically; pneumatically; using a screw fit; using a friction fit; and, using an interference fit.

In one embodiment, the valve module and the other valve module are screwably attachable to the body and the valve module can be interchanged with the other valve module by unscrewing the valve module from the body and screwing the other valve module to the body.

In one embodiment, the valve module and the other valve module are frictionally attachable to the body and wherein the valve module can be interchanged with the other valve module by placing pressure on the valve module to overcome the valve module's frictional attachment to the body and frictionally attaching the other valve module to the body.

In one embodiment, fully deforming the flexible membrane places pressure on the valve module overcoming the valve module's frictional attachment to the body.

In one broad form, a robot, the robot including: a chassis; at least one appendage attached to the chassis; and, an apparatus for dampening forces attached to each appendage; the apparatus including: a body; a flexible membrane attached to the body to define an internal cavity, the membrane being configured to deform in response to an applied force; an outlet valve configured to allow fluid transfer out of the internal cavity as the flexible membrane deforms whereby, as fluid is transferred out of the internal cavity, the applying force is dampened; and, an inlet valve configured to allow fluid to transfer into the internal cavity, wherein at least one of the outlet valve and the inlet valve can be interchanged with another valve to adjust at least one of: an amount of fluid that can be transferred; and, a rate at which fluid can be transferred.

It will be appreciated that the broad forms of the invention and their respective features can be used in conjunction and/or independently, and reference to separate broad forms is not intended to be limiting Furthermore, it will be appreciated that features of the method can be performed using the system or apparatus and that features of the system or apparatus can be implemented using the method.

### BRIEF DESCRIPTION OF THE DRAWINGS

Various examples and embodiments of the present invention will now be described with reference to the accompanying drawings, in which:

FIG. 1 is a schematic drawing of the apparatus; and,

FIG. 2 is a schematic drawing of a robot including the apparatus.

### DETAILED DESCRIPTION OF THE PREFERRED EMBODIMENTS

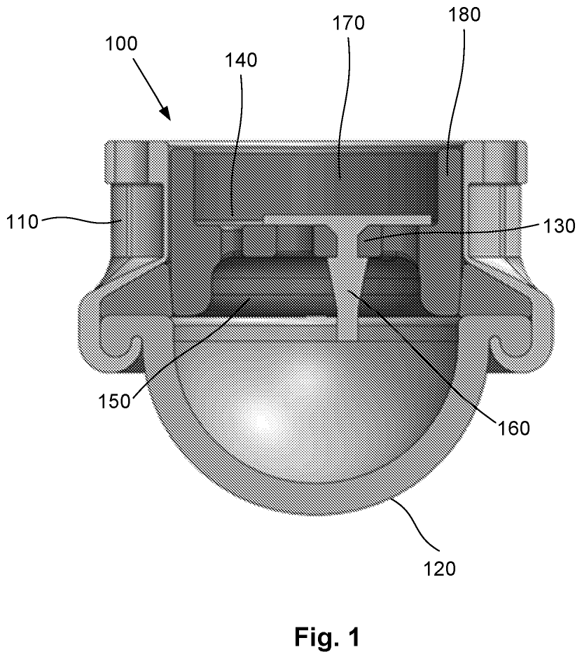

An example of an apparatus for dampening forces on a robot appendage will now be described with reference to FIG. 1.

The apparatus 100 includes a body 110, which may further include a flexible membrane 120, an outlet valve 130 and an inlet valve 140. The body 110 may roughly be in the form of a hollow cylinder, such that the outlet valve 130 and inlet valve 140 may be housed within the hollow section of the body 110. Further, the body 110 could also include depressions such that the flexible membrane 120 can attach to the body 110 by hooking into the depressions. A person skilled in the art would appreciate that the body 110 could take many different forms (i.e. a hollow cube, hollow rectangular prism etc.) and include different attachment means to be best suited to the desired implementation of the invention.

The flexible membrane 120 is attached to the body 110 and is shaped to define an internal cavity 150. Applying a force to the flexible membrane 120 deforms the flexible membrane 120. Depending on the implementation of the invention, the flexible membrane 120 can be resilient so that the membrane 120 is restored to its original shape when a force is no longer applied to it or the apparatus 100 may further include an additional system that induces the flexible membrane 120 to return to its original shape, such as a spring or other biasing mechanism.

The outlet valve 130 is configured to allow fluid, such as air, to transfer out of the internal cavity 150 as the flexible membrane 120 deforms, such that transferring fluid out of the internal cavity 150 causes a force applied to the membrane to be dampened so that this cushions an impact. In addition, this dampening may also reduce spring effects that are inherent to most materials and thereby improve controllability.

An inlet valve 140 is provided to control fluid transfer back into the internal cavity 150, which in turn controls a rate of restoration of the membrane shape. In this regard, with the flexible membrane 120 in its original shape, or when a force is applied, fluid pressure within the internal cavity 150 prevents fluid from transferring into the internal cavity 150 through the inlet valve 140 so that the membrane retains its shape. As an applied force is removed, and the flexible membrane 120 returns to its original shape, fluid pressure within the internal cavity 150 is reduced, allowing fluid to transfer into the internal cavity through the inlet valve 140.

Thus, the combination of the outlet valve 130 and inlet valve 140 operate to manage the flow of fluid into and out of the internal cavity 150 in order to dampen forces and to reset the apparatus in preparation to receive a subsequent force. In one example, this can be used to absorb forces on a robot appendage, such as a leg. Specifically, the body 110 can be attached to an end of a robot leg, so that the apparatus acts as a foot. In this example, as the robot walks, the membrane 140 impacts the ground, with the impact being dampened as fluid flows through the outlet valve 130. As the robot leg is lifted, fluid returns into the membrane through the inlet valve 140 so that the apparatus 100 is ready for the next impact.

It will be appreciated that properties of the dampening and reset are specific to the particular valves used, meaning the apparatus needs to be configured to a particular application, and is then specific to that application. However, in some situations it may desirable to adjust the properties, for example depending on the nature of a surface being traversed by a robot, an intended robot gait, robot speed, or the like.

Accordingly, the outlet valve 130 and/or inlet valve 140 can be interchanged with another valve to adjust the amount of fluid that can be transferred and/or the rate of fluid that can be transferred. Interchanging at least one of the valves to adjust the amount or rate of fluid transfer alters the strength and characteristics of force dampening and mitigation of spring effects of the apparatus 100, ensuing the cushioning provided by the apparatus is optimised for the intended application. Thus, by varying the strength and characteristics of force dampening, a single implementation of the invention can be adjusted to be used in a variety of dampening applications, thereby increasing the flexibility of the apparatus 100 and reducing the amount of resources required to address a plurality of dampening applications.

Additionally, should any of the valves become damaged, the apparatus 100 can be repaired without replacing functional components, such as the body 110. Depending on the implementation of the invention, the outlet 130 and inlet valves 140 can be interchanged in a number of ways that a person skilled in the art would be familiar with.

A number of additional features will now be described.

In one embodiment, the other valve has at least one of: an increased flow resistance; a reduced flow resistance; an increased flow capacity; and, a reduced flow capacity. To adjust the amount of fluid that can be transferred or the rate of fluid that can be transferred, the other valve may have different resistance or flow capacity. In a first example, another outlet valve 130 has a higher resistance and/or a lower flow capacity than the outlet valve 130, resulting in fluid more slowly and more consistently transferring out of the internal cavity 150, making the apparatus 100 more suitable to dampening larger forces that are applied over a duration. In a second example, the other outlet valve has a lower resistance and/or a higher flow capacity than the outlet valve 140. This may result in a lower delay for fluid to transfer out the internal cavity 150 and/or for the rate of transfer to be increased, making the apparatus 100 more suitable to an application where rapid dampening of lower forces is required. Similar effects can be achieved by altering the inlet valves, allowing the membrane 140 to restore to the original shape more or less rapidly as needed.

A person skilled in the art would be able to appreciate that additional combinations resistance and flow capacity could be used to tailor the apparatus 100 to additional applications. Therefore, by replacing one of the valves with the other valve having different properties, the apparatus can be adjusted to better suit the force that is to be dampened.

In one embodiment, the inlet valve 140 is configured to allow fluid transfer into the internal cavity 150 after the applying force is no longer being applied and/or when there is a reduction in the force applied by the applying force. By only allowing fluid to transfer into the internal cavity 150 after the force is no longer applied/there is a reduction in force, it will reduce the probability that refilling the internal cavity 150 will interfere with the dampening of the force.

In one embodiment, the body 110 may further include a storage cavity configured to receive fluid that transfers out of the internal cavity 150. Additionally, the storage cavity may also be configured to supply fluid that is transferred into the internal cavity 150. The storage cavity may also include additional fluid, should be desirable to replace lost fluid, further fill or overfill the internal cavity 150. A person skilled in the art would also appreciate that, in a separate embodiment, the apparatus 100 could include a storage cavity that is not included in the body 110.

In one embodiment, the inlet valve 140 is a one way valve to prevent fluid from transferring from the internal cavity 150 through the inlet valve 140. Further, the outlet valve 130 is a one way valve to prevent fluid from transferring into the internal cavity 150 through the outlet valve 130. If the valves were two way, it may result in fluid moving in opposition to the fluid flow out of or into the internal cavity 150, thereby interfering with dampening characteristics and refill characteristics. By including one way valves it reduces the probability that natural fluid movements can interfere with dampening/refill characteristics, thereby improving the consistency of the apparatus 100.

In one embodiment, the outlet valve 130 includes a diaphragm which is configured to prevent backflow via the outlet. Additionally the diaphragm can be configured to at least partially control fluid transfer, for example using a more resilient diaphragm so that a greater pressure is required to force fluid through the outlet valve. In this example, it will be appreciated that changing the valve includes changing a diaphragm, for example replacing the diaphragm with a more or less resilient diaphragm. Additionally and/or alternatively, the valve can include an opening through a valve module 180, with a diameter of the opening controlling a flow rate through the valve.

In one embodiment, as the flexible membrane 120 is deformed, the flexible membrane 120 places pressure on the diaphragm so that is temporarily no longer blocks the outlet valve 130. The diaphragm could also be utilised instead of a one way outlet valve 130 to reduce the costs, as a single diaphragm may be used to block the outlet valve 130 rather than including one way mechanisms in the outlet valve 130 and any valves interchanged with the outlet valve 130.

The diaphragm could be integrated into the body 110 such that deformation of the flexible membrane 120 causes the diaphragm to be moved so that the diaphragm no longer prevents fluid from transferring out of the internal cavity 150. Doing so removes the need for an additional mechanism to be included in the body 110 that moves the diaphragm once the flexible membrane 120 has deformed to the desired position, reducing costs and reducing potential points of failure.

In one embodiment, at least one of the inlet valve 140 and the outlet valve 130 are removably and replaceably attached to the body 110. Additionally, the inlet valve 140 and/or the outlet valve 130 may be attached to the body 110 magnetically, pneumatically, using a screw fit, using a friction fit, using an interference fit, or the like. By removeably/replaceably attaching the valves to the body 110, either of the valves may be removed/replaced without necessarily removing/replacing the other valve. This allows greater flexibility in tuning the apparatus 100 and may also reduce costs as valves that do not need to be replaced do not need to be replaced.

Depending on how regularly the valves are to be interchanged, a means for removable/replaceable attachment may be chosen. When creating a higher quality apparatus 100 that is likely to be subject to more regular interchanging, a screw fit may be chosen which is less likely to be damaged over time. When creating a lower quality apparatus 100 that is not likely to be subject to regular interchanging, a friction fit may be chosen which is more straightforward to use and less costly to develop.

In one embodiment, the fluid may be air or water. A person skilled in the art would appreciate that any fluid may be used depending on the implementation of the invention. For example, the fluid may be air to ensure a lighter apparatus 100 while lowering costs, although other fluids, such as water, may be used where thermal conduction of the apparatus 100 may be relevant.

In one embodiment, the apparatus 100 includes a valve module 180 which includes the outlet valve 130 and the inlet valve 140. Additionally, the valve module may be interchanged with another valve module in order to interchange the inlet valve 140 and/or the outlet valve 130. Interchanging valves individually may be time costly as it could require the manipulation of small tools within the confined space inside the apparatus 100. Allowing valves to be interchanged individually may also increase the cost of developing the apparatus 100 as additional mechanisms may be required to allow the valves to be individually replaceable from the body 110. By including a valve module that includes the valves, only the valve module itself needs to be replaced. This can save on development costs, as only a single mechanism is required to replace the entire valve module, and therefore replace multiple valves, rather than individual mechanisms for each valve, and reduce the time taken to replace valves as it is less likely to require precision tools and skills in order to replace the larger valve module. Including a valve module has an additional advantage of allowing a multiple of valves to be replaced at the same time if desired, further reducing time taken to replace valves.

Additionally, the valve module could be attached to the body 110 magnetically, pneumatically, using a screw fit, using a friction fit, using an interference fit, or the like. When creating a higher quality apparatus 100 that is likely to be subject to more regular interchanging, a screw fit may be chosen which is less likely to be damaged over time. When creating a lower quality apparatus 100 that is not likely to be subject to regular interchanging, a friction fit may be chosen which is more straight forward to use and less costly to develop. Therefore, depending on how regularly the valve module is to be interchanged, a means for removable/replaceable attachment may be chosen.

In one embodiment, the valve module and the other valve module are screwably attachable to the body 110 and the valve module can be interchanged with the other valve module by unscrewing the valve module from the body 110 and screwing the other valve module to the body 110. By screwably attaching the valve module and the other valve module to the body 110, the valve module can be interchanged by manipulating only a single, simple mechanism. This allows an untrained user to easily and quickly interchange the valve module while reducing the cost of the mechanism.

In one embodiment, the valve module and the other valve module are frictionally attachable to the body 110 and wherein the valve module can be interchanged with the other valve module by placing pressure on the valve module to overcome the valve module's frictional attachment to the body 110 and frictionally attached the other valve module to the body 110. Additionally, fully deforming the flexible membrane 120 places pressure on the valve module overcoming the valve module's frictional attachment to the body 110. As similarly described in the above paragraph, frictional attachment to the body 110 allows an untrained user to interchange the valve module in a simple and quick manner. An additional benefit derived from using a frictional attachment is there is a reduced possibility that the frictional attachment will accidentally loosen due to vibrations or other forces as the apparatus 100 is used over time.

Further, by utilising a frictional attachment, it may be possible to interchange the valve module in a plurality of ways, which may be chosen depending on the preferred implementation of the invention. For example, fully depressing the flexible membrane 120 may place sufficient pressure on the valve module in order to overcome the frictional attachment. Doing so may allow a user to interchange the valve module without specialised tools, facilitating an easier interchange process.

An example of the apparatus 100 will now be described with reference to FIG. 1.

As described previously, the apparatus 100 includes a body 110, which may further include a flexible membrane 120, an outlet valve 130 and an inlet valve 140, and the flexible membrane 120 is attached to the body 110 and this attachment defines an internal cavity 150.

The outlet valve 130 may further include a diaphragm 160 that can adjust the amount of fluid or rate of fluid that is transferred to the internal cavity 150 through the outlet valve 130. Depending on the resistance to deformation or size of the diaphragm 160, the fluid or rate of fluid that is transferred may be further adjusted.

The body 110 may further include a storage cavity 170 that receives fluid that transfers out of internal cavity 150 when the outlet valve 130 allows fluid to transfer out of the internal cavity 150. The storage cavity 170 is also configured to supply fluid that the inlet valve 140 so that fluid can be transferred into the internal cavity 150.

The body 110 may further include a valve module 180 that includes the inlet valve 140 and the outlet valve 130. The valve module 180 may be interchanged with another valve module (not shown) to interchange either of the valves. The valve module 180 may to be attached to the body 110 in a plurality of ways, as a person skilled in the art would be able to determine as suitable for the preferred implementation of the invention.

The apparatus 100 may be used with legged robots to dampen the touchdown impact and reduce the spring effects inherent to most materials. It may consistent of a flexible membrane 120 with an air filled internal cavity 150.

The flow of fluid in and out of the internal cavity 150 is controlled by two valves. Fluid is forced out of the cavity when the flexible membrane 120 impacts a surface. The flow of air through the valves controls the degree of spring and dampening the foot exhibits. The outlet valve 130 is typically one way to prevent air from rushing back into the cavity and reducing the spring rate of the flexible membrane 120. The inlet valve 140 can be tuned to allow the flexible membrane 120 to restore to its original state just before the next impact.

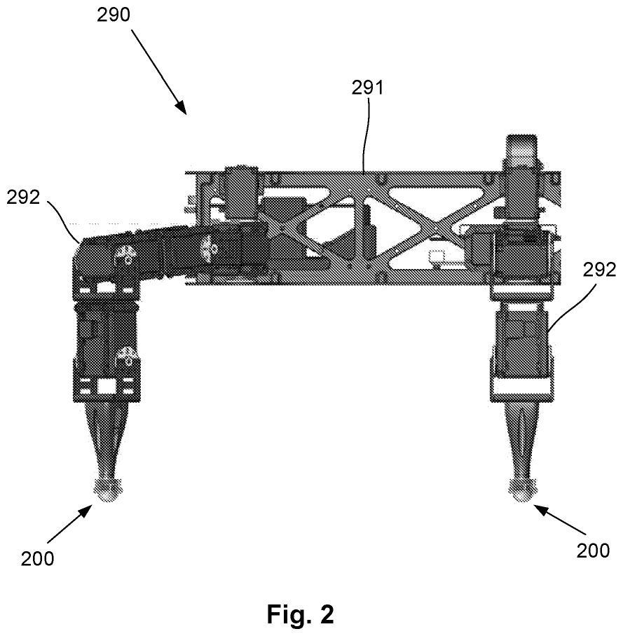

An example of a robot including an apparatus 200 for dampening forces will now be described with reference to FIG. 2.

A robot 290 may include a chassis 291 and at least one appendage 292 attached to the chassis 291. In this example, the chassis 291 has two appendages 292 attached where the appendages 292 take the form of legs. Each of the appendages 292 include an apparatus 200 on the bottom portion of the appendage 292 so that the apparatus 200 can dampen forces the appendages 292 would otherwise be subjugated to as a result of locomotion, such as walking or running In this example, the apparatus 292 may further act as a foot for the robot 290, so that as the robot 290 walks, the apparatus 200 impacts the ground, the impact being dampened by the apparatus 200. As the appendage 292 is lifted, the apparatus 200 resets so that it may dampen the next impact, with the duration of refill of the membrane being set based on an expected gait of the robot, and hence time between subsequent impacts.

Throughout this specification and claims which follow, unless the context requires otherwise, the word “comprise”, and variations such as “comprises” or “comprising”, will be understood to imply the inclusion of a stated integer or group of integers or steps but not the exclusion of any other integer or group of integers. As used herein and unless otherwise stated, the term “approximately” means±20%.

Persons skilled in the art will appreciate that numerous variations and modifications will become apparent. All such variations and modifications which become apparent to persons skilled in the art, should be considered to fall within the spirit and scope that the invention broadly appearing before described.

1. An apparatus for dampening forces on a robot appendage, the apparatus including:
a) a body;
b) a flexible membrane attached to the body to define an internal cavity, the membrane being configured to deform in response to an applied force;
c) an outlet valve configured to allow fluid transfer out of the internal cavity as the flexible membrane deforms whereby, as fluid is transferred out of the internal cavity, the applying force is dampened; and,
d) an inlet valve configured to allow fluid to transfer into the internal cavity, wherein at least one of the outlet valve and the inlet valve can be interchanged with another valve to adjust at least one of:
i) an amount of fluid that can be transferred; and,
ii) a rate at which fluid can be transferred.

2. An apparatus according to claim 1, wherein the other valve has at least one of:
a) an increased flow resistance;
b) a reduced flow resistance;
c) an increased flow capacity; and,
d) a reduced flow capacity.

3. An apparatus according to claim 1, wherein the inlet valve is configured to allow fluid transfer into the internal cavity after at least one of:
a) the applying force is no longer being applied; and,
b) there is a reduction in the force applied by the applying force.

4. An apparatus according to claim 1, wherein the outlet valve includes a diaphragm which is configured to at least partially reduce an amount of fluid or a rate at which fluid can be transferred out of the internal cavity.

5. An apparatus according to claim 4, wherein the reduction is determined by at least one of:
a) resistance of the diaphragm; and,
b) size of the diaphragm.

6. An apparatus according to claim 4, wherein, as the flexible membrane deforms, the reduction in amount of fluid or rate of fluid transfer reduces.

7. An apparatus according to any one of claims 4, wherein, as the flexible membrane is deformed, the flexible membrane places pressure on the diaphragm so that it temporarily no longer blocks the outlet valve.

8. An apparatus according to claim 1, wherein the body includes a storage cavity configured to receive fluid that transfers out of the internal cavity.

9. An apparatus according to claim 1, wherein the storage cavity is configured to supply fluid that is transferred into the internal cavity.

10. An apparatus according to claim 1, wherein the inlet valve is a one way valve to prevent fluid from transferring from the internal cavity through the inlet valve.

11. An apparatus according to claim 1, wherein the outlet valve is a one way valve to prevent fluid from transferring into the internal cavity through the outlet valve.

12. An apparatus according to claim 1, wherein the fluid is at least one of:
a) air; and,
b) water.

13. An apparatus according to claim 1, wherein at least one of the inlet valve and the outlet value are removably and replaceably attached to the body.

14. An apparatus according to claim 13, wherein at least one of the inlet valve and the outlet valve are attached to the body at least one of:
a) magnetically;
b) pneumatically;
c) using a screw fit;
d) using a friction fit; and,
e) using an interference fit.

15. An apparatus according to claim 1, wherein the apparatus includes a valve module which includes the outlet valve and the inlet valve.

16. An apparatus according to claim 15, wherein the valve module can be interchanged with another valve module in order to interchange at least one of:
a) the inlet valve; and,
b) the outlet valve.

17. An apparatus according to claim 15, wherein the valve module is attached to the body at least one of:
a) magnetically;
b) pneumatically;
c) using a screw fit;
d) using a friction fit; and,
e) using an interference fit.

18. An apparatus according to claim 15, wherein the valve module and the other valve module are screwably attachable to the body and the valve module can be interchanged with the other valve module by unscrewing the valve module from the body and screwing the other valve module to the body.

19. An apparatus according to claim 15, wherein the valve module and the other valve module are frictionally attachable to the body and wherein the valve module can be interchanged with the other valve module by placing pressure on the valve module to overcome the valve module's frictional attachment to the body and frictionally attaching the other valve module to the body.

20. An apparatus according to claim 15, wherein fully deforming the flexible membrane places pressure on the valve module overcoming the valve module's frictional attachment to the body.

21. A robot, the robot including:
a) a chassis;
b) at least one appendage attached to the chassis; and,
c) an apparatus for dampening forces attached to each appendage; the apparatus including:
i) a body;
ii) a flexible membrane attached to the body to define an internal cavity, the membrane being configured to deform in response to an applied force;
iii) an outlet valve configured to allow fluid transfer out of the internal cavity as the flexible membrane deforms whereby, as fluid is transferred out of the internal cavity, the applying force is dampened; and,
iv) an inlet valve configured to allow fluid to transfer into the internal cavity, wherein at least one of the outlet valve and the inlet valve can be interchanged with another valve to adjust at least one of:
(1) an amount of fluid that can be transferred; and,
(2) a rate at which fluid can be transferred.
